(19) United States
(12) Patent Application Publication
(10) Pub. No.: US 2021/0043146 A1
(43) Pub. Date: Feb. 11, 2021

(54) ELECTRONIC DEVICE AND DISPLAY CONTROL METHOD THEREFOR

(71) Applicant: Samsung Electronics Co., Ltd., Gyeonggi-do (KR)

(72) Inventors: Jeonggyu JO, Gyeonggi-do (KR); Joohan KIM, Gyeonggi-do (KR); Hyeongsoon PARK, Gyeonggi-do (KR); Hyunwoo SIM, Gyeonggi-do (KR)

(21) Appl. No.: 16/984,308

(22) Filed: Aug. 4, 2020

(30) Foreign Application Priority Data
Aug. 7, 2019 (KR) 10-2019-0096120

(51) Int. Cl. G09G 3/3266

(52) U.S. Cl. CPC G09G 3/3266; G09G 2300/0842; G09G 2360/144

(57) ABSTRACT

Provided is an electronic device. The electronic device may include a display including a plurality of pixels; at least one processor electrically connected to the display; a display driving circuit to drive the display; and a sensor disposed on at least an upper portion of a rear surface of the display, wherein, when a signal for activating the sensor is detected, the processor is configured to: control the display driving circuit to turn off at least one pixel included in a first area of the display where the sensor is disposed among the plurality of pixels; and control the display driving circuit to turn on at least one pixel included in a second area of the display excluding the first to area among the plurality of pixels.

### CROSS-REFERENCE TO RELATED APPLICATIONS

This application is based on and claims priority under 35 U.S.C. § 119 to Korean Patent Application No. 10-2019-0096120 filed on Aug. 7, 2019, in the Korean Intellectual Property Office, the disclosure of which is incorporated by reference herein in its entirety.

### BACKGROUND

### 1. Field

Certain embodiments of the disclosure relate to an electronic device and a display control method therefor.

### 2. Description of Related Art

Electronic devices are available in various sizes according to functions and user preferences. An electronic device may include a large-screen touch display for wide visibility and ease of manipulation. The large-screen touch display can be exposed through the entire area of the front plate of the electronic device.

The above information is presented as background information only to assist with an understanding of the disclosure. No determination has been made, and no assertion is made, as to whether any of the above might be applicable as prior art with regard to the disclosure.

### SUMMARY

According to certain embodiments of the disclosure, there is provided an electronic device. The electronic device may include a display including a plurality of pixels; at least one processor electrically connected to the display; a display driving circuit to drive the display; and a sensor disposed on at least an upper portion of a rear surface of the display, wherein, when a signal for activating the sensor is detected, the processor is configured to: control the display driving circuit to turn off at least one pixel included in a first area of the display where the sensor is disposed among the plurality of pixels; and control the display driving circuit to turn on at least one pixel included in a second area of the display excluding the first area among the plurality of pixels.

According to certain embodiments of the disclosure, there is provided a display control method for the electronic device. The display control method may include: detecting a signal for activating a sensor; controlling a display driving circuit to turn off at least one pixel included in a first area of the display where the sensor is disposed among a plurality of pixels included in the display; and controlling the display driving circuit to turn on at least one pixel included in a second area of the display excluding the first area among the plurality of pixels.

According to certain embodiments of the disclosure, the electronic device may have a high transmittance for light output from a light emitting part of at least one sensor because the at least one sensor is installed over the inactive area and the rear surface of an upper portion of the display having different transmittances.

According to certain embodiments of the disclosure, the electronic device may have a high transmittance for light output from a light emitting part of at least one sensor through the inactive area and the rear surface of an upper portion of the display having different transmittances because the at least one sensor is installed over the rear surface of the upper portion of the display.

According to certain embodiments of the disclosure, when a signal for activating at least one sensor is detected, the electronic device may turn off at least one pixel included in an area of the display where the at least one sensor is installed, preventing the organic light emitting diode (OLED) from being turned on due to the leakage of light output from a light emitting part of the at least one sensor.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram of an electronic device in a network environment according to certain embodiments;

FIG. 2 is a front perspective view illustrating an electronic device according to certain embodiments;

FIG. 3 is a rear perspective view illustrating an electronic device according to certain embodiments;

FIG. 4 is an exploded perspective view illustrating an electronic device according to certain embodiments;

FIG. 5 depicts a sensor installed in an electronic device according to certain embodiments;

FIG. 6A is a view illustrating a stacked structure of the display according to certain embodiments;

FIG. 6B is a view illustrating another stacked structure of the display according to certain embodiments;

FIG. 7 is a diagram depicting a display driving operation according to certain embodiments;

FIG. 8 illustrates a pixel driving circuit for driving a pixel according to certain embodiments;

FIG. 9 depicts a display control method according to certain embodiments; and

FIG. 10 is a flowchart depicting a display control method according to certain embodiments.

### DETAILED DESCRIPTION

As the display area is expanded, the inactive area in the display module may be reduced. As a result, at least one sensor (e.g., illuminance sensor and/or infrared sensor) for sensing the external environment may be disposed under the display panel.

However, when at least one sensor (e.g., illuminance sensor and/or infrared sensor) is disposed under the display panel, a blinking spot may be caused on the display due to light output from a light emitting part included in the at least one sensor. The blinking spot is caused when the sensor emits light, that added to the light from the pixel, causes an area to appear brighter before the sensor light is turned off, thus appearing to blink. The blinking spot reduces the quality of and distorts the display.

Certain aspects of the disclosure have been made in view of the above problem, among others. Accordingly, the disclosure is to provide an electronic device in which at least one sensor is disposed over the inactive area and the rear surface of an upper portion of the display or is disposed over the rear surface of an upper portion of the display.

In addition, the disclosure is to provide an electronic device that can turn off at least one pixel included in an area of the display where at least one sensor is disposed upon detecting a signal for activating the at least one sensor. In certain embodiments, turning off the at least one pixel avoids the blinking spot, thereby improving the user experience.

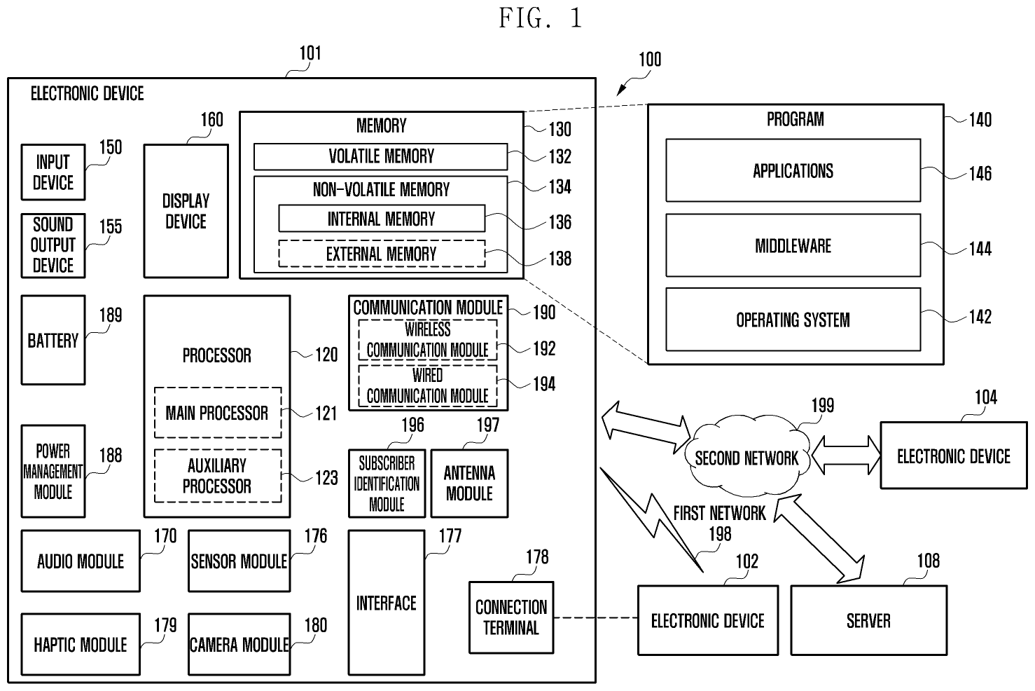

FIGS. 1-4 describe an electronic device where certain embodiments of the disclosure can be practices, though it is noted that embodiments of the present disclosure can be practiced elsewhere. It is noted that where the display and sensor are overlapping when viewed from a front surface of the electronic device, the brightness from light emitted by the sensor added to the brightness of the light from pixels in the vicinity of the sensor can cause a blinking spot to appear.

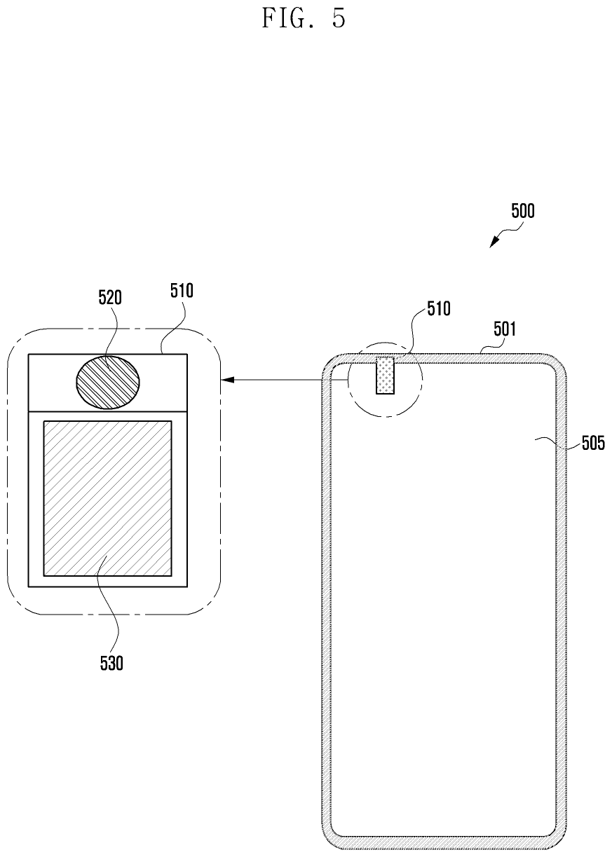

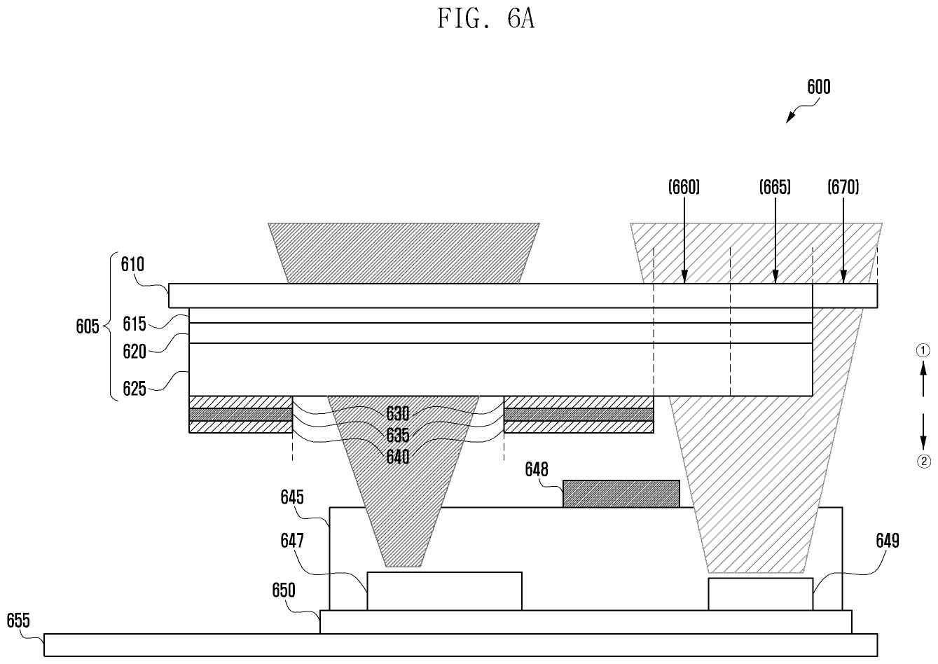

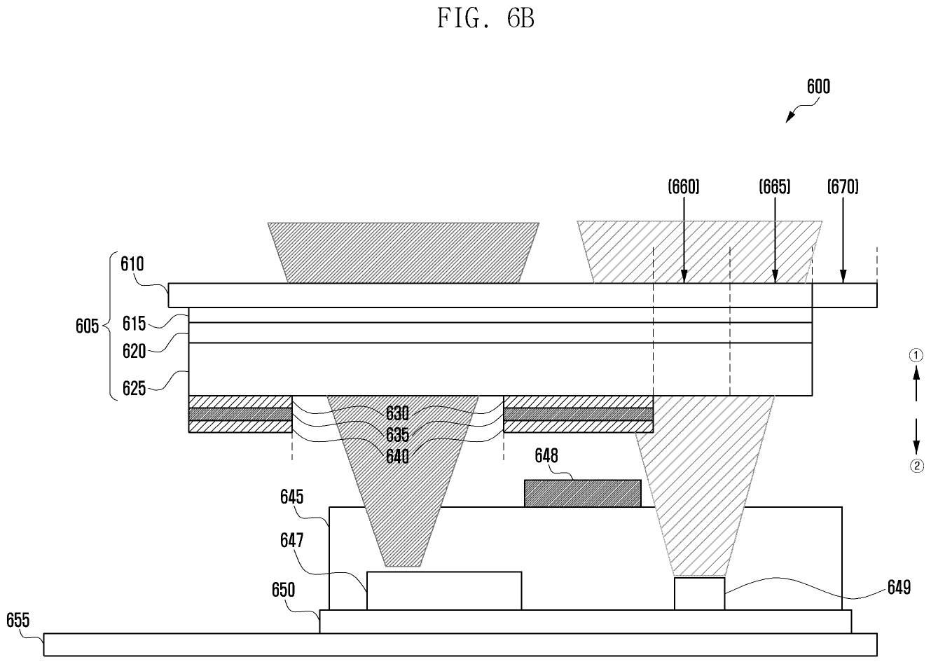

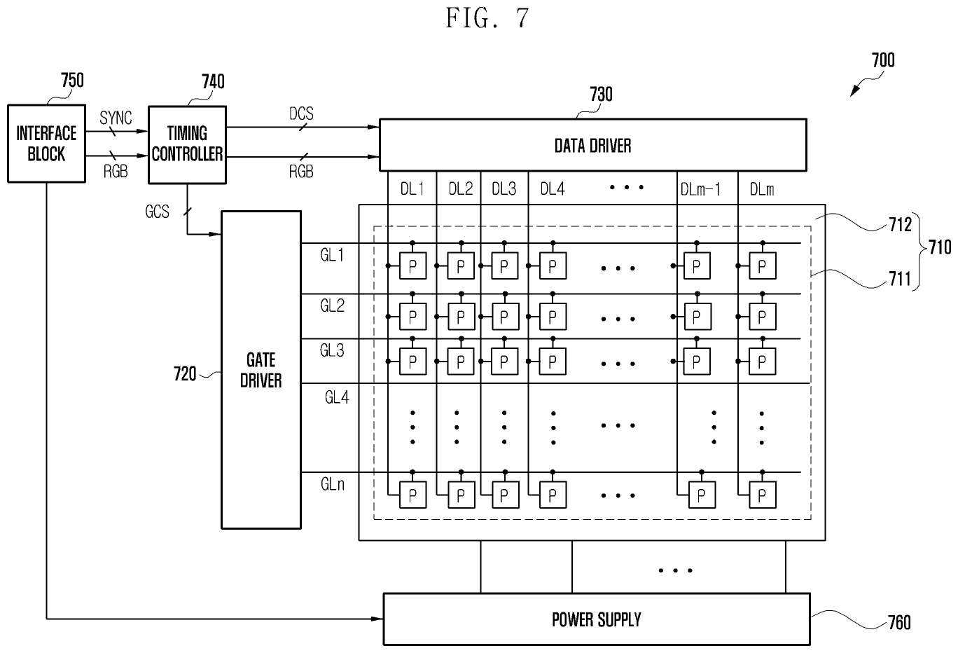

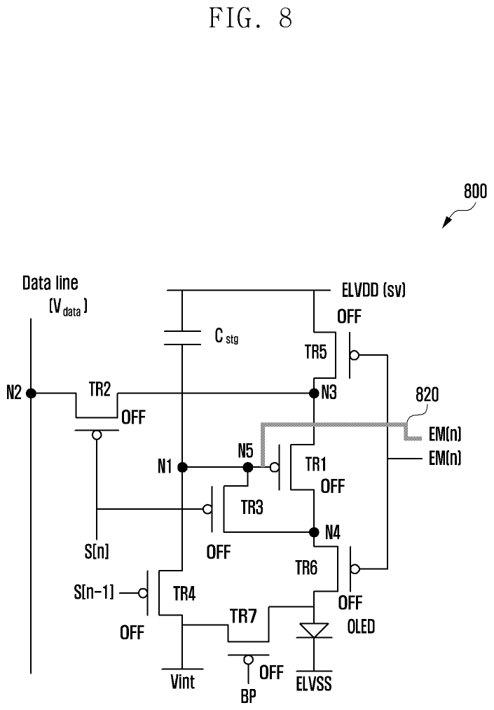

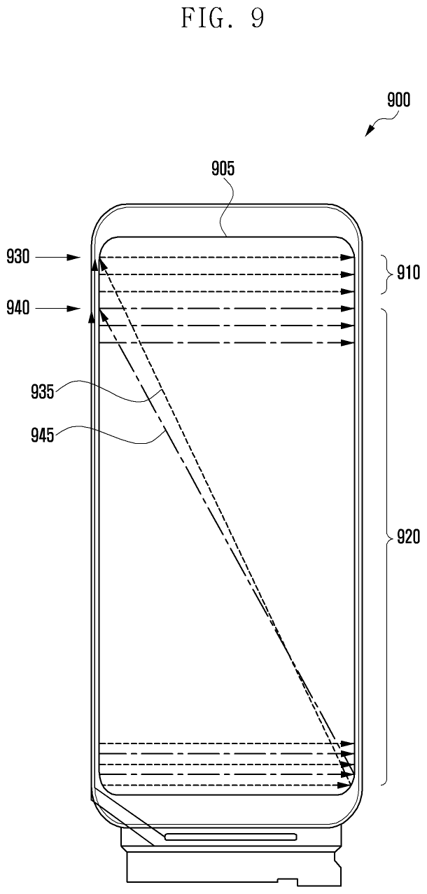

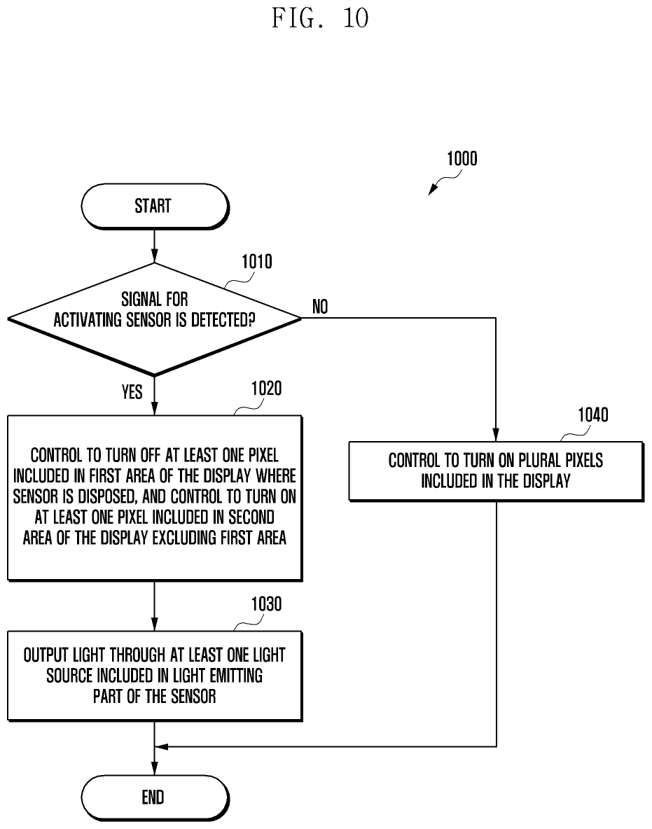

Certain aspects of FIGS. 5-9 describe the display and sensor where the foregoing is alleviated. FIG. 5 is a block diagram disclosing the sensor and display overlapping when viewed directly from above the front surface of the electronic device. FIGS. 6A and 6B disclose a cross section of the display and sensor. FIG. 7 discloses a data driver and gate driver driving pixels of the display. FIG. 8 discloses a pixel circuit for driving some of the pixels of the display, and FIG. 9 describes turning off some of the pixels while driving other pixels. FIG. 10 describes a method flow diagram.

### Electronic Device

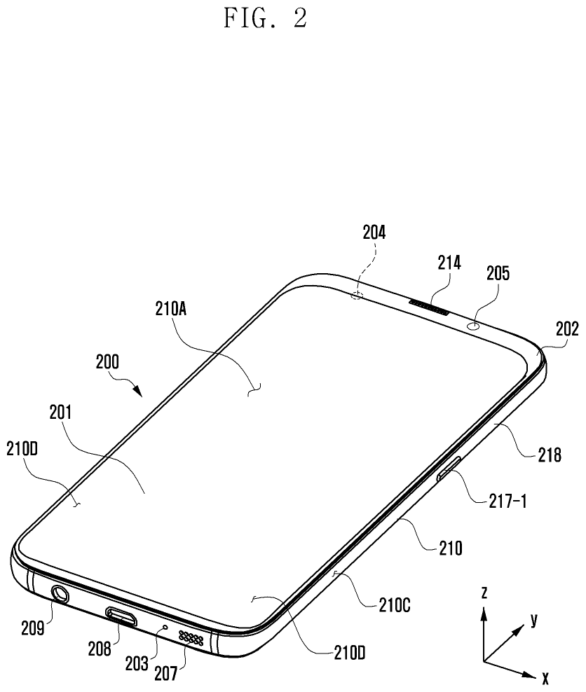

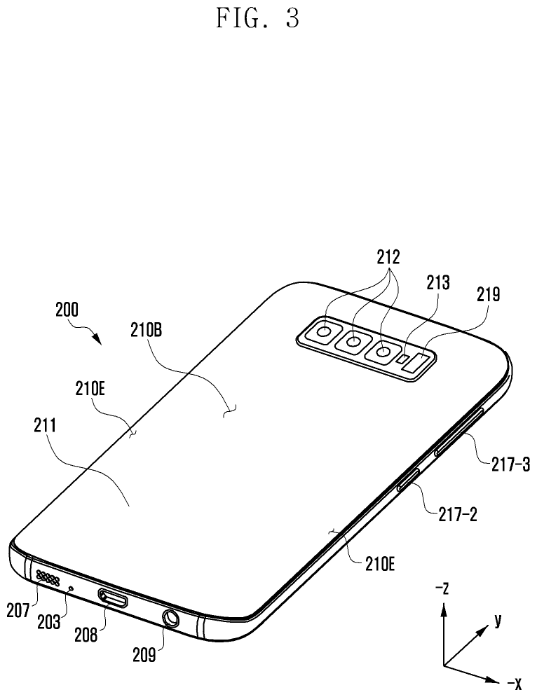

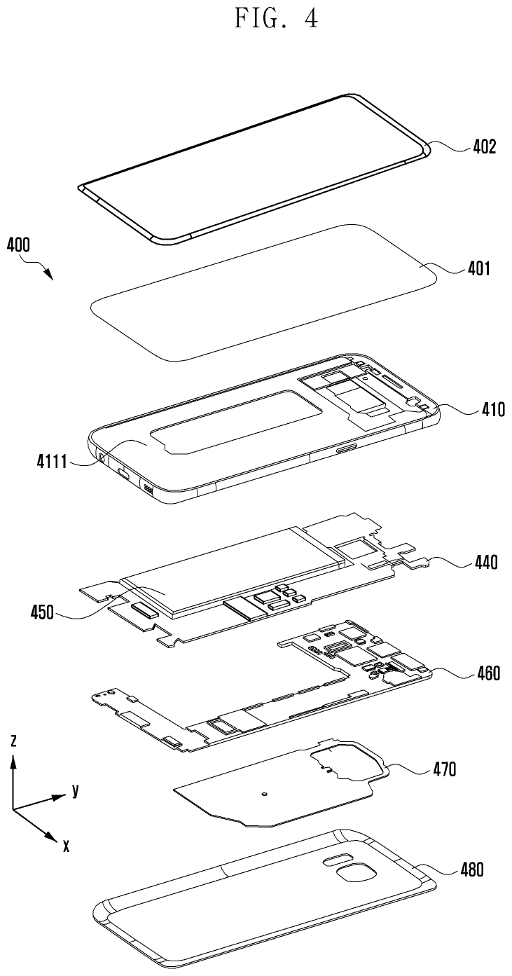

FIG. 1 describes the functional features of an electronic device 101. FIGS. 2 and 3 describe a housing of the electronic device. FIG. 4 describes internal structures of the electronic device.

FIG. 1 is a block diagram of an electronic device 101 in a network environment 100 according to certain embodiments.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The term “processor” shall be understood to refer to both the singular and plural contexts.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) (e.g., speaker or headphone) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor. The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) (e.g., a wireless transceiver) or a wired communication module 194 (e.g., a local area network (LAN) communication module or a power line communication (PLC) module) (e.g., a wired transceiver). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element implemented by a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

FIG. 2 is a front perspective view illustrating an electronic device 200 according to certain embodiments.

FIG. 3 is a rear perspective view illustrating an electronic device 200 according to certain embodiments.

Referring to FIGS. 2 and 3, the electronic device 200 (e.g., the electronic device 101 of FIG. 1) according to certain embodiments may include a housing 210 including a first surface (or front surface) 210A, a second surface (or rear surface) 210B, and a side surface 210C enclosing a space between the first surface 210A and the second surface 210B. In one embodiment (not illustrated), the housing may refer to a structure forming some of the first surface 210A, the second surface 210B, and the side surface 210C. According to one embodiment, the first surface 210A may be formed by an at least partially substantially transparent front plate 202 (e.g., a polymer plate or a glass plate including various coating layers). The second surface 210B may be formed by a substantially opaque rear plate 211. The rear plate 211 may be formed by, for example, coated or colored glass, ceramic, polymer, metal (e.g., aluminum, stainless steel (STS), or magnesium), or a combination of at least two of the above materials. The side surface 210C may be coupled to the front plate 202 and the rear plate 211 and be formed by a side bezel structure (or “side member”) 218 including a metal and/or a polymer. In some embodiments, the rear plate 211 and the side bezel structure 218 may be integrally formed and include the same material (e.g., metal material such as aluminum).

In the illustrated embodiment, the front plate 202 may include two first regions 2310D bent and extended seamlessly from the first surface 210A toward the rear plate 211 at both ends of a long edge of the front plate 202. In the illustrated embodiment (see FIG. 3), the rear plate 211 may include two second regions 210E bent and extended seamlessly from the second surface 210B towards the front plate 202 at both ends of a long edge. In some embodiments, the front plate 202 (or the rear plate 211) may include only one of the first regions 210D (or the second regions 210E). In one embodiment, a portion of the first regions 210D or the second regions 210E may not be included. In the above embodiments, when viewed from the side surface of the electronic device 200, the side bezel structure 218 may have a first thickness (or width) at a side surface in which the first region 210D or the second region 210E is not included and have a second thickness smaller than the first thickness at a side surface including the first region 210D or the second region 210E.

According to one embodiment, the electronic device 200 may include at least one of a display 201; audio modules 203, 207, and 214 (e.g., an audio module 170 of FIG. 1); sensor modules 204 and 219 (e.g., a sensor module 176 of FIG. 1); camera modules 205, 212, and 213 (e.g., a camera module 180 of FIG. 1); key input device 217-1, 217-2, and 217-3 (e.g., an input device 150 of FIG. 1); indicator (not illustrated); and connector holes 208 and 209. In some embodiments, the electronic device 200 may omit at least one (e.g., the key input device 217-1, 217-2, and 217-3 or the indicator) of the components or may further include other components.

The display 201 may be exposed through, for example, a substantial portion of the front plate 202. In some embodiments, at least part of the display 201 may be exposed through the front plate 202 forming the first region 210D of the side surface 210C and the first surface 210A. In some embodiments, an edge of the display 201 may be formed to be substantially the same as an adjacent outer edge shape of the front plate 202. In one embodiment (not illustrated), in order to enlarge an area where the display 201 is exposed, a distance between an outer edge of the display 201 and an outer edge of the front plate 202 may be formed to be substantially the same.

In an embodiment (not illustrated), in a portion of a screen display area of the display 201, a recess or an opening may be formed, and at least one of the audio module 214 and the sensor module 204, the camera module 205, and the indicator (not illustrated) aligned with the recess or the opening may be included. In one embodiment (not illustrated), at a rear surface of a screen display area of the display 201, at least one of the audio module 214, the sensor module 204, and the camera module 205 may be included. In one embodiment (not illustrated), the display 201 may be coupled to or disposed adjacent to a touch detection circuit, a pressure sensor capable of measuring intensity (pressure) of the touch, and/or a digitizer for detecting a stylus pen of a magnetic field method. In some embodiments, at least part of the sensor modules 204 and 219 and/or at least part of the key input device 217-1, 217-2, and 217-3 may be disposed in a first region 210D and/or a second region 210E.

The audio modules 203, 207, and 214 may include a microphone hole 203 and speaker holes 207 and 214. The microphone hole 203 may dispose a microphone for obtaining an external sound therein; and, in some embodiments, a plurality of microphones may be disposed to detect a direction of a sound. The speaker holes 207 and 214 may include an external speaker hole 207 and a call receiver hole 214. In some embodiments, the speaker holes 207 and 214 and the microphone hole 203 may be implemented into one hole, or the speaker may be included without the speaker holes 207 and 214 (e.g., piezo speaker).

The sensor modules 204 and 219 may generate an electrical signal or a data value corresponding to an operating state inside the electronic device 200 or an environment state outside the electronic device 200. The sensor modules 204 and 219 may include, for example, a first sensor module 204 (e.g., proximity sensor) and/or a second sensor module (not illustrated) (e.g., fingerprint sensor), disposed at the first surface 210A of the housing 210, and/or a third sensor module 219 (e.g., a heart rate monitor (HRM) sensor). The first sensor module 204 may be disposed under the display 201 among the first surface 210A. In connection with the first sensor module 204, certain embodiments will be described in FIGS. 6A and 6B described below. The fingerprint sensor may be disposed at the second surface 210B as well as the first surface 210A (e.g., the display 201) of the housing 210. The fingerprint sensor (e.g., an ultrasonic sensor or an optical fingerprint sensor) may be disposed under the display 201 among the first surface 210A. The electronic device 200 may further include a sensor module (not illustrated), for example, at least one of a gesture sensor, gyro sensor, air pressure sensor, magnetic sensor, acceleration sensor, grip sensor, color sensor, IR sensor, biometric sensor, temperature sensor, humidity sensor, and illumination sensor 204.

The camera modules 205, 212, and 213 may include a first camera device 205 disposed at the first surface 210A of the electronic device 200, a second camera device 212 disposed at the second surface 210B thereof, and/or a flash 213. The camera modules 205 and 212 may include one or a plurality of lenses, an image sensor, and/or an image signal processor. The flash 213 may include, for example, a light emitting diode or a xenon lamp. In some embodiments, two or more lenses (infrared camera, wide angle and telephoto lens) and image sensors may be disposed at one surface of the electronic device 200.

The key input device 217-1, 217-2, and 217-3 may be disposed at the side surface 210C of the housing 210. In one embodiment, the electronic device 200 may not include some or all of the above-described key input devices 217-1, 217-2, and 217-3, and the key input device 217-1, 217-2, and 217-3 that is not included may be implemented in other forms such as a soft key on the display 201. In some embodiments, the key input device may be implemented using a pressure sensor included in display 201.

The indicator (not illustrated) may be disposed at, for example, the first surface 210A of the housing 210. The indicator may provide, for example, status information of the electronic device 200 in an optical form. In one embodiment, the indicator may provide, for example, a light source interworking with an operation of the camera module 205. The indicator may include, for example, a light emitting diode (LED), an IR LED, and a xenon lamp.

The connector ports 208 and 209 may include a first connector port 208 that may receive a connector (e.g., a USB connector or interface connector port module (IF module)) for transmitting and receiving power and/or data to and from an external electronic device and/or a second connector hole (e.g., earphone jack) 209 that can receive a connector for transmitting and receiving audio signals to and from an external electronic device.

FIG. 4 is an exploded perspective view illustrating an electronic device 200 according to certain embodiments.

Referring to FIG. 4, the electronic device 400 (e.g., the electronic device 101 of FIG. 1, the electronic device 200 of FIG. 2) may include a side bezel structure 410, first support member 411 (e.g., bracket), front plate 420, display 430 (e.g., the display 201 of FIG. 2), printed circuit board 440, battery 450 (e.g., the battery 189 of FIG. 1), second support member 460 (e.g., rear case), antenna 470, and/or rear plate 480 (e.g., the rear plate 211 of FIG. 3). In some embodiments, the electronic device 400 may omit at least one (e.g., the first support member 411 or the second support member 460) of the components or may further include other components. At least one of the components of the electronic device 400 may be the same as or similar to at least one of the components of the electronic device of FIG. 1 or 2 and a duplicated description is omitted below.

The first support member 411 may be disposed inside the electronic device 400 to be connected to the side bezel structure 410 or may be integrally formed with the side bezel structure 410. The first support member 411 may be made of, for example, a metal material and/or a non-metal (e.g., polymer) material. In the first support member 411, the display 430 may be coupled to one surface thereof, and the printed circuit board 440 may be coupled to the other surface thereof. In the printed circuit board 440, a processor (e.g., the processor 120 of FIG. 1), a memory (e.g., the memory 130 of FIG. 1), and/or an interface (e.g., the interface 177 of FIG. 1) may be mounted. In one embodiment, the processor, the memory, and the interface are the same as the processor 120, the memory 130, and the interface 177 of FIG. 1, so a duplicate description will be omitted.

The battery 450 is a device for supplying power to at least one component of the electronic device 400 and may include, for example, a non-rechargeable primary battery, a rechargeable secondary battery, or a fuel cell. At least part of the battery 450 may be disposed, for example, on substantially the same plane as that of the printed circuit board 440. The battery 450 may be integrally disposed inside the electronic device 400 or may be detachably disposed in the electronic device 400.

The antenna 470 may be disposed between the rear plate 480 and the battery 450. The antenna 470 may include, for example, a near field communication (NFC) antenna, wireless charging antenna, and/or magnetic secure transmission (MST) antenna. The antenna 470 may perform, for example, short range communication with an external electronic device (e.g., electronic device 102, 104, server 108) or may wirelessly transmit and receive power required for charging. In one embodiment, an antenna structure may be formed by some or a combination of the side bezel structure 410 and/or the first support member 411.

It is noted that the display device 160 may consume almost all if not all of the first surface 210A. This provides the user with more viewing area. However, as a result, the sensor module 170 uses a surface of the first surface 210 that is co-located with a portion of the first surface 210A used by the display device 170. The sensor module 170 can use a light emitter to emit light. However, if the brightness of the light from the light emitter is added to the brightness of the pixels of the display device 160 that are on the same surface, a spot will temporarily appear on the first surface 210A which is brighter than the surrounding region. This will be perceived as a blinking spot. In certain embodiments, the blinking spot is alleviated by turning of the pixels proximate to the sensor module 170.

FIGS. 5-9 will describe the display (such as display device 160) and sensor (such as sensor module 170).

### Display and Sensor

### Front Surface

FIG. 5 is a diagram 500 depicting a sensor 510 installed in an electronic device 501 according to certain embodiments.

In one embodiment, the sensor 510 may include a light emitting part 520 and a light receiving part 530. The light emitting part 520 and the light receiving part 530 may be arranged on a printed circuit board (e.g., printed circuit board 440 in FIG. 4) for operation. In one embodiment, the sensor 510 may include a proximity illumination sensor or a time of flight (ToF) sensor.

In one embodiment, the sensor 510 may be disposed on the rear surface of at least an upper portion of the display 505. For example, the light emitting part 520 of the sensor 510 may be disposed to be spaced apart from the rear surface of the display panel (not shown) of the display 505 so as to overlap at least some region of a window (not shown) (e.g., front plate 202 in FIG. 2) disposed on the top surface of the display 505. The at least some region of the window includes a region of that window that does not overlap the display panel and that does overlap the display panel. The region of the window (not shown) that does not overlap the display panel can include an inactive area where no screen is displayed.

As used herein, overlap shall be understood as overlapping, appearing co-located or directly above/below when viewed from above the window, and does not require the items be located on the same plane.

In one embodiment, the light receiving part 530 of the sensor 510 may be disposed to be spaced apart from the rear surface of the display panel (not shown) so as to overlap at least some other region of the window (not shown).

In another embodiment, although not shown, the light emitting part 520 of the sensor 510 may be disposed to be spaced apart from the rear surface of the display panel (not shown) so as to overlap at least some region of the window (not shown) overlapping the display panel.

Certain embodiments related to the arrangement structure of the sensor 510 will be described later with reference to FIGS. 6A and 6B.

### Cross Section View

FIG. 6A is a view 600 illustrating a stacked structure of the display 605 according to certain embodiments.

In FIG. 6A, the display 605 includes an active area 660, a view area 665, and an inactive area 670 that overlap a sensor 645, while the active area 660 and view area 665 overlap a light emitting part 649 of the sensor 645. Additionally, the lighted by the light emitter passes through the active area 660, the view area 665 and the inactive area 670. The view area 665 and the inactive area 670 can have higher light transmittance than the active area 660.

In FIG. 6B, the active area 660, view area 665, and inactive area 670 overlap a sensor 645, while the active area 660 overlaps a light emitting part 649 of the sensor 645. Additionally, the lighted by the light emitter passes through the active area 660, and the view area 665. The view area 665 and the inactive area 670 can have higher light transmittance than the active area 660.

With reference to FIG. 6A, the display 605 may include a plurality of stacked layers. The display 605 may include a window 610, a first adhesive layer 615, a polarizing plate 620, and a display panel 625. In one embodiment, the display 605 may be at least partially similar to the display device 160 in FIG. 1, the display 201 in FIG. 2, the display 430 in FIG. 4, and/or the display 505 in FIG. 5.

The window 610 may define a front plate (e.g., front plate 202 in FIG. 2). The window 610 may be arranged to face a first direction (\textcircled{1}). The window 610 may protect the display panel 625 within the display 605 from external shocks or scratches. The window 610 may be made of a transparent material. The window 610 may transmit light to the inside or outside of the electronic device (e.g., electronic device 101 in FIG. 1). The window 610 may be a cover glass made of tempered glass, reinforced plastic, or flexible polymer material. In one embodiment, the window 610 may include a polyimide window.

The first adhesive layer 615 may include a pressure sensitive adhesive (PSA), an optical clear adhesive (OPA), a heat-reactive adhesive, a general adhesive, or double-sided tape.

The polarizing plate 620 may prevent light generated from the display 605 from being diffusely reflected or being diffused in an unintended direction. The polarizing plate 620 may be made of a polyethylene terephthalate (PET) film or a tri-acetyl cellulose (TAC) film.

The display panel 625 may be disposed on the rear surface of the front plate (e.g., window 610). For example, the rear surface may mean a surface facing a second direction (\textcircled{2}). In one embodiment, the display panel 625 may include a control circuit. The control circuit may include a display driver IC (DDI) and/or a touch display driver IC (TDDI) arranged using chip-on-panel (COP) or chip-on-film (COF) technology. The display panel 625 may receive power and emit light under the control of the control circuit. The display panel 625 may include a touch sensor that detects a touch signal input through the front plate.

A second adhesive layer 630, a PET (polyester) film 635, and a third adhesive layer 640 may be attached under the display panel 625. As the second adhesive layer 630, the PET (polyester) film 635, and the third adhesive layer 640 are attached under the display panel 625, it is possible to prevent light generated from the light emitting part 649 from directly entering into the light receiving part 647.

A PCB 655 (e.g., printed circuit board 440 in FIG. 4) may be included under the housing (e.g., housing 210 in FIG. 2). A sensor die 650 may be stacked on the PCB 655. A sensor 645 (e.g., sensor 510 in FIG. 5) may be disposed on one surface of the sensor die 650.

The sensor 645 may include a light receiving part 647 (e.g., light receiving part 530 in FIG. 5) and a light emitting part 649 (e.g., light emitting part 520 in FIG. 5). The light receiving part 647 may include one or more photo detectors (or sensors) (e.g., photo diode (PD)) capable of detecting light rays in one or more wavelength bands. The light emitting part 649 may include various types of light emitting elements such as a light emitting diode (LED). In one embodiment, a separator 648 may be formed between the light receiving part 647 and the light emitting part 649. The separator 648 may prevent light generated by the light emitting part 649 from directly entering into the light receiving part 647.

The display 605 may include at least two regions having different transmittances. The light emitting part 649 may be disposed to be spaced apart from the rear surface (e.g., second direction (\textcircled{2}) of the display 605 so as to overlap at least two regions having different transmittance among the regions of the display 605. For example, the light emitting part 649 may be disposed to be spaced apart from the rear surface of the display panel 625 so as to overlap at least a region 670 of the window 610 not overlapping the display panel 625 and at least a region 660 or 665 of the window 610 overlapping the display panel 625. At least some region of the window 610 not overlapping the display panel 625 may include an inactive area 670 where no screen is displayed. At least some region of the window 610 overlapping the display panel 625 may include at least a portion of the active area (AA) 660 and a view area (VA) 665. The view area 665 may be at least a portion of the inactive area 670.

The inactive area 670 may include an area (e.g., non-display area) that has a width and is arranged to at least partially surround the periphery of the active area 660 occupying substantially most of the display 605.

In one embodiment, the inactive area 670 may include a region in which a gate driver, an emission driver (ED), and/or wiring lines for controlling the display 605 are disposed. In the view area 665, a gate driver, an emission driver, and/or wiring lines may be arranged in the same manner as the inactive area 670, but the placement spacing may be wider compared to the inactive area 670. As the spacing between the gate driver, the emission driver, and/or the wiring lines arranged in the view area 665 is wider than that in the inactive area 670, the transmittance of the view area 665 may be higher than the transmittance of the inactive area 670.

In one embodiment, the transmittances of the active area 660, the view area 665, and the inactive area 670 may be different from each other. As the light emitting part 649 is arranged to overlap the active area 660, the view area 665, and the inactive area 670 having different transmittances, the transmittance may be higher compared with the transmittance with active area 660, alone. For example, a description is given on the assumption that the transmittance of the active area 660 is 4%, the transmittance of the view area 665 is 15%, and the transmittance of the inactive area 670 is 85%. However, in certain embodiments of the disclosure, as light emitted from the light emitting part 649 is transmitted through regions having different transmittances, it is possible to obtain a transmittance of 22.4% (e.g., 2.4% in the active area 660, 3% in the view area 665, and 17% in the inactive area 670). It can be seen that the transmittance of light emitted from the light emitting part 649 according to certain embodiments of the disclosure (e.g., 22.4%) is 5.6 times higher than where the transmittance is 4% uniformly.

In one embodiment, when a signal for activating the sensor 645 is detected, the display driving circuit (DDI) may control at least one pixel included in one region of the display 601 overlapping the light emitting part 649 of the sensor 645 (e.g., some of the active area 660, and view area 665, and some of the inactive area 607) to be turned off, and may control at least one pixel included in the remaining region of the display 601 (e.g., region not overlapping the light emitting part 649) to be turned on.

In various embodiments, the inactive area 670 has been described as an area having a certain width that is arranged to at least partially surround the periphery of the active area 660, but it is not limited thereto. For example, the inactive area 670 may refer to an area including at least one pixel turned off as a signal for activating the sensor 645 is detected among the area of the display 601 that overlap the light emitting part 649 of the sensor 645 (e.g., some of the active area 660, view area 665, and some of the inactive area 607).

FIG. 6B is a view 680 illustrating a stacked structure of the display 605 according to certain embodiments.

In one embodiment, the display 605, the window 610, the first adhesive layer 615, the polarizing plate 620, the display panel 625, the second adhesive layer 630, the PET (polyester) film 635, the third adhesive layer 640, the sensor 645, the light receiving part 647, the separator 648, the sensor die 650, and the PCB 655 shown in FIG. 6B are the same as those in FIG. 6A. For a description thereon, refer to the description given in relation to FIG. 6A. In the following description on FIG. 6B, only a configuration different from that of FIG. 6A will be described.

In the above description on FIG. 6A, the light emitting part 649 has been described as being arranged to be spaced apart from the rear surface of the display 605 (e.g., second direction (\textcircled{2}) so as to overlap at least two regions having different transmittances among the regions of the display 605. But it is not limited thereto. For example, with reference to FIG. 6B, the light emitting part 649 may be disposed to be spaced apart from the rear surface of the display panel 625 (e.g., second direction (\textcircled{2}) so as to overlap at least a region of the window 610 overlapping the display panel 625, such as the active area (AA) 660, among the regions of the display 605.

As can be seen in FIGS. 6A and 6B, light emitted from the light emitting part 649 passes through the active area 660 and view area 665, as well as light from the pixels underneath. If light is emitted from both the light from the light emitting part 649 and the pixels in the active area 660 and the view area 665, the active area 660 and the view area 665 will appear brighter than the remaining area of the display, while the light emitting part 649 is on, causing a blinking spot to appear.

To prevent this, in one embodiment, when a signal for activating the sensor 645 is detected, the display driving circuit (DDI) may control at least one pixel included in one region of the display 601 overlapping the light emitting part 649 of the sensor 645 (e.g., some of the active area 660) to be turned off, and may control at least one pixel included in the remaining region of the display 601 (e.g., excluding some of the active area 660) to be turned on.

FIG. 7 will describe the display panel 710, while FIG. 8 describe a pixel driving circuit.

### Pixels of the Display

FIG. 7 is a diagram 700 depicting a display driving operation according to certain embodiments. As will be described below, the display panel 710 comprises pixels P, which are located in a display area 711. A processor can selectively turn off certain pixels P, such as pixels P that overlap a light emitting part 645. The processor can selectively turn off the pixels when a sensor signal is detected.

With reference to FIG. 7, the display panel 710 (e.g., display panel 625 in FIGS. 6A and 6B) may include a display area 711 (e.g., active area 660 in FIGS. 6A and 6B) for outputting image data to the outside, and a non-display area 712 (e.g., view area 665 and/or inactive area 670 in FIGS. 6A and 6B) other than the display area 711. The display area 711 may refer to a region where a plurality of pixels are arranged to output image data. The non-display area 712 may indicate an area excluding the display area 711 among the areas constituting the external appearance of the electronic device (e.g., electronic device 101 in FIG. 1). For example, the non-display area 712 may include a region where certain circuit elements (e.g., gate driver and/or emission driver (ED)) and wiring lines (e.g., scan lines, data lines, ELVDD wiring and/or ELVSS wiring) are arranged. For example, the non-display area 712 may include a region where a display driving circuit (DDI) for applying a signal to pixels in the display area 711 and/or wiring lines electrically connecting the pixels with the display driving circuit are arranged. In one embodiment, at least some of the wiring lines may be disposed in at least a portion of the display area 711 as well as the non-display area 712. For example, each of the pixels P in the display area 711 may include one or more sub pixels (not shown). The display panel 710 may include a plurality of gate lines (GL) (GL1 to GLn) and a plurality of data lines (DL) (DL1 to DLm) intersecting each other. A pixel P may be formed at a portion where a gate line GL and a data line DL intersect. In one embodiment, each pixel P may include a pixel driving circuit to drive an organic light emitting diode (OLED).

The display panel 710 may include a control circuit (not shown) for driving the display panel 710. The control circuit (not shown) may include a display driver IC (DDI) and/or a touch display driver IC (TDDI) installed using chip-on-panel (COP) or chip-on-film (COF) technology. The display driving circuit (DDI) may include a gate driver 720 (scan driver or scan driving circuit), a data driver 730 (data driving circuit), a timing controller 740, and/or an interface block 750.

The pixel driving circuit provided in each pixel P may include at least one of at least one switch, at least one capacitor (e.g., storage capacitor (Cstg)), or a light emitting element (e.g., organic light emitting diode (OLED)). The at least one switch may include a transistor (T), a thin film transistor (TFT), a field effect transistor (FET), or a metal-oxide-semiconductor field effect transistor (MOSFET).

In the following description, it is assumed that the at least one switch is a thin film transistor (TFT).

At least one thin film transistor (TFT) may charge the capacitor with a data voltage supplied from the data line DL in response to the scan signal supplied from the gate line GL. The at least one thin film transistor (TFT) may control the amount of current supplied to the corresponding pixel P (e.g., organic light emitting diode) according to the data voltage charged in the capacitor.

The gate driver 720 may supply scan signals (or, scan pulses) to a plurality of gate lines GL1 to GLn according to at least one gate control signal (GCS) provided from the timing controller 740. The gate driver 720 may include a gate shift register to output a scan signal. The scan signal is supplied to individual pixels P in sequence, and may be composed of single or multiple signals. When the scan signal is composed of plural signals, each gate line GL may be composed of plural lines for supplying plural scan signals to each pixel P. For example, the gate driver 720 may be connected to column lines being cathode terminals of the display panel 710 and select the corresponding column line in sequence.

The data driver 730 may convert image data RGB provided from the timing controller 740 into a data voltage according to at least one data control signal (DCS) provided from the timing controller 740. The data driver 730 may generate a data voltage by using a plurality of gamma correction voltages. The data driver 730 may sequentially supply the generated data voltage to a plurality of pixels in line units (or, in row units). The data driver 730 may include a data shift register to output a sampling signal, a latch circuit to latch image data RGB in line units in response to the sampling signal, and a digital analog converter (DAC) to convert the latched image data into an analog gradation voltage (e.g., pixel voltage).

The timing controller 740 may align the image data RGB provided from the interface block 750 according to the size and resolution of the display panel 710. The timing controller 740 may supply the aligned image data RGB to the data driver 730. The timing controller 740 may transmit a plurality of control signals (e.g., GCS, DCS) by using at least one synchronization signal (SYNC) provided from the interface block 750. The plurality of control signals may include at least one gate control signal (GCS) and at least one data control signal (DCS). The gate control signal (GCS) may include a signal for controlling the driving timing of the gate driver 720. The data control signal (DCS) may include a signal for controlling the driving timing of the data driver 730. The synchronization signals (SYNC) may include a dot clock signal (DCLK), a data enable signal (DE), a horizontal synchronization signal (Hsync), or a vertical synchronization signal (Vsync).

The interface block 750 may receive image data RGB from the processor (e.g., processor 120 in FIG. 1) and transmit the received image data RGB to the timing controller 740. The interface block 750 may generate at least one synchronization signal (SYNC) and transmit it to the timing controller 740. The interface block 750 may control the power supply 760 (e.g., power management module 188 in FIG. 1) to supply at least one driving voltage to the display panel 710.

The display panel 710 may include a backlight module (BLU) (not shown).

The power supply 760 may generate at least one driving voltage required for driving the display panel 710 and supply the generated driving voltage to the display panel 710. In one embodiment, the power supply 760 may be configured as a single part or plural parts, so that at least one driving voltage can be independently supplied to at least a portion of the display area 711. The at least one driving voltage may include, for example, ELVDD, ELVSS, gate-on voltage, gate-off voltage, and/or initialization voltage. In one embodiment, the gate-on voltage may be a voltage for turning on at least one thin film transistor (TFT) provided in the display panel 710.

The gate-off voltage may be a voltage for turning off at least one thin film transistor (TFT) provided in the display panel 710. The initialization voltage may be a voltage for initializing at least one node provided in a pixel driving circuit for driving at least one pixel P among plural pixels P.

The pixels P are associated with a pixel driving circuit which will be described in FIG. 8. The pixels that overlap the light emitting part 645 include an additional line allowing the processor to turn off the pixel during detection of usage of the sensor.

### Pixel Driving Circuit

FIG. 8 illustrates a pixel driving circuit 800 for driving a pixel according to certain embodiments.

With reference to FIG. 8, the pixel driving circuit for each pixel P of the display panel (e.g., display panel 710 in FIG. 7) may include seven thin film transistors (e.g., first thin film transistor TR1 (switching transistor), second thin film transistor TR2 (driving transistor), third thin film transistor TR3 (compensation transistor), fourth thin film transistors TR4 (initialization transistor), fifth and sixth thin film transistors TR5 and TR6 (first light emitting transistor and second light emitting transistor), seventh thin film transistor TR7 (discharge transistor)), a storage capacitor (Cstg), and an organic light emitting diode (OLED). The pixel driving circuit for each pixel P is for improving the process variation of the thin film transistors TR1 to TR7 and the response speed of the pixel, and can be changed or modified in various ways.

In certain embodiments, pixels in an area overlapping the light emitting part 645 of the sensor include an additional line 820 connected to node N5 at the gate of transistor TR1. When a signal for activating a sensor is detected, line 820 is not supplied, turning off transistor TR1 and preventing the OLED from receiving current. Since the OLED does not receive current, the OLED does not emit light. Thus the pixel is off.

In one embodiment, the gate driver (e.g., gate driver 720 in FIG. 7) may transmit a gate signal to the gate terminal of the fourth thin film transistor TR4 for a first time. As the gate signal is received, the fourth thin film transistor TR4 may be turned on during the first time. When the fourth thin film transistor TR4 is turned on, an initialization voltage Vint may be applied to a first node N1 and the gate terminal of the first thin film transistor TR1. The initialization voltage Vint may initialize the voltage applied to the gate terminal of the first thin film transistor TR1.

In one embodiment, the gate driver may transmit a gate signal to the gate terminals of the second thin film transistor TR2 and the third thin film transistor TR3 for a second time. As the gate signal is received, the second thin film transistor TR2 and the third thin film transistor TR3 may be turned on. When the second thin film transistor TR2 is turned on, a second node N2 and a third node N3 may become substantially the same node, and a first voltage (e.g., data voltage Vdata) may be applied to the third node N3 through the second thin film transistor TR2. When the third thin film transistor TR3 is turned on, a fourth node N4 and a fifth node N5 may become substantially the same node, and a second voltage may be applied to the fifth node N5 and the first node N1 through the third thin film transistor TR3. The second voltage may indicate the sum of the first voltage and the threshold voltage of the first thin film transistor TR1. Through the above process, the second voltage may be applied to one terminal of the storage capacitor Cstg, and a third voltage (eg, ELVDD) may be applied to the other terminal of the storage capacitor Cstg. The second voltage and the third voltage may charge the storage capacitor Cstg. The charged storage capacitor Cstg may apply a voltage higher than or equal to the threshold voltage to the gate terminal of the first thin film transistor TR1 for a third time. As a voltage higher than or equal to the threshold voltage is applied to the gate terminal of the first thin film transistor TR1, the first thin film transistor TR1 may be turned on for the third time.

In one embodiment, the display driver IC (DDI) (not shown) (or, timing controller (e.g., timing controller 740 in FIG. 7)) can turn on the emission driver (ED) (not shown) for a third time. The emission driver may transmit an emission signal EM to the gate terminals of the fifth thin film transistor TR5 and the sixth thin film transistor TR6 for the third time. As the emission signal EM is transmitted to the gate terminals of the fifth thin film transistor TR5 and the sixth thin film transistor TR6, the fifth thin film transistor TR5 and the sixth thin film transistor TR6 may be turned on. When the first thin film transistor TR1, the fifth thin film transistor TR5, and the sixth thin film transistor TR6 are turned on, a current may flow through the first thin film transistor TR1, the fifth thin film transistor TR5, and the sixth thin film transistor TR6. This current may cause the organic light emitting diode (OLED) to emit light.

In certain embodiments, the pixel driving circuit for each pixel P of the display panel (e.g., display panel 710 in FIG. 7) may be configured differently. For example, the display panel may include a first area and a second area. The first area of the display panel may be composed of an area overlapping the light emitting part of the sensor (e.g., light emitting part 649 of the sensor 645 in FIGS. 6A and 6B). The second area of the display panel may be composed of an area other than the first area.

In one embodiment, the pixel driving circuit for a pixel included in the first area of the display panel may be configured as illustrated in FIG. 8. For example, each pixel P in the second area of the display panel can include a line 820 (or wiring) connecting the first thin film transistor TR1 and the emission driver ED. A pixel included in the second area of the display panel may not include line 820.

In one embodiment, when a signal for activating a sensor of the electronic device (e.g., electronic device 101 in FIG. 1) is detected under the control of the processor (e.g., processor 120 in FIG. 1), the display driving circuit (not shown) may differently drive the pixel driving circuit for the first region of the display panel and the pixel driving circuit for the second region thereof. For example, the signal for activating the sensor may include a signal for detecting the proximity of an external object on the display, and a signal for executing a specific application (e.g., telephone application).

In one embodiment, when a signal for activating the sensor is detected under the control of the processor, the display driving circuit may drive the pixel driving circuit for a pixel included in the second area of the display panel according to the above-described way so that the first thin film transistor TR1, the fifth thin film transistor TR5, and the sixth thin film transistor TR6 are turned on. In response to turning-on of the first thin film transistor TR1, the fifth thin film transistor TR5, and the sixth thin film transistor TR6, the pixel driving circuit for a pixel included in the second area of the display panel may control the organic light emitting diode (OLED) to emit light (e.g., turned on) by using the current flowing through the first thin film transistor TR1, the fifth thin film transistor TR5, and the sixth thin film transistor TR6.

In one embodiment, when a signal for activating the sensor of the electronic device (e.g., electronic device 101 in FIG. 1) is detected under the control of the processor, the emission driver (ED) of the pixel driving circuit for a pixel included in the first area of the display panel may supply a gate-off voltage to the gate terminals of the first, fifth and sixth thin film transistors TR1, TR5 and TR6 through the line 820, so that the first, fifth and sixth thin film transistors TR1, TR5 and TR6 are turned off. As the first, fifth and sixth thin film transistors TR1, TR5 and TR6 are turned off, the organic light emitting diode (OLED) may be turned off.

In one embodiment, as the area of the window (e.g., window 610 in FIGS. 6A and 6B) of the electronic device occupied by the display increases, as described above with reference to FIG. 6A or 6B, a portion (e.g., light emitting part 649 in FIGS. 6A and 6B) of the sensor (e.g., sensor 645 in FIGS. 6A and 6B) may be disposed over the rear surface of the display (e.g., second direction \textcircled{2}in FIGS. 6A and 6B). In this arrangement, when the display is turned on and the sensor is operated (for example, when light is output by at least one light source included in the light emitting part of the sensor), the output light may affect the display. For example, light output from at least one light source may leak, and a blinking spot may occur on the display due to the light leakage.

According to the above embodiments, when a gate-off voltage is supplied to the gate terminals of the fifth and sixth thin film transistors TR5 and TR6 to turn off the fifth and sixth thin film transistors TR5 and TR6, and a gate-off voltage is also supplied through the line 820 directly to the gate terminal of the first thin film transistor TR1 to turn off the first thin film transistor TR1, at least one pixel included in the corresponding area of the display may be turned off. As at least one pixel included in the corresponding area of the display is turned off, the organic light emitting diode (OLED) may be not turned on although light output from at least one light source included in the light emitting part of the sensor leaks.

### Operation of the Display and Sensor

FIG. 9 depicts a display control method according to certain embodiments. With reference to FIG. 9, when a signal for activating the sensor (e.g., sensor 645 in FIGS. 6A and 6B) is detected under the control of the processor (e.g., processor 120 in FIG. 1), the display driving circuit (DDI) may differently drive the first area 910 and the second area 920 of the display panel 905 (e.g., display panel 710 in FIG. 7). For example, the first area 910 of the display panel 905 may include an area overlapping the light emitting part of the sensor (e.g., light emitting part 649 of the sensor 645 in FIGS. 6A and 6B), and the second area 920 of the display panel 905 may include an area other than the first area 910. When a signal for activating the sensor is detected, the processor causes the first area 910 overlaps the light emitting part 645, the pixels in the pixels in the first area 910 can be turned off.

As described above with reference to FIG. 8, when a signal for activating the sensor is detected, the emission driver ED of the pixel driving circuit for a pixel included in the first area 910 of the display panel 905 may not supply an emission signal (EM) through the line (e.g., line 820 in FIG. 8) to the gate terminals of the first, fifth and sixth thin film transistors TR1, TR5 and TR6 to turn off the first, fifth and sixth thin film transistors TR1, TR5 and TR6. As the first, fifth and sixth thin film transistors TR1, TR5 and TR6 are turned off, the organic light emitting diode (OLED) may be turned off. When a signal for activating the sensor is detected, the pixel driving circuit for a pixel included in the second area 920 of the display panel 905 may turn on the first, fifth and sixth thin film transistors TR1, TR5 and TR6 to turn on the organic light emitting diode (OLED) by using the current flowing through the first thin film transistor TR1, the fifth thin film transistor TR5, and the sixth thin film transistor TR6.

In one embodiment, an emission frame line mark (EM FLM) signal may be generated while the waveform of the emission signal is shifted at regular time intervals. The display panel 905 receiving the emission signal at regular time intervals may sequentially emit light for each line. The display driving circuit (not shown) may control the emission FLM signal for applying the emission signal according to whether a signal for controlling the display is detected.

For example, when a signal for activating the sensor is detected under the control of the processor, the display driving circuit (not shown) may control the emission FLM signal 940 to apply the emission signal to the second area 920 except for the first area 910. As the emission signal is applied only to the second area 920 excluding the first area 910, only the area 945 corresponding to the second area 920 among the entire area of the display panel 905 may be turned on.

When a signal for activating the sensor is not detected under the control of the processor, the display driving circuit may control the emission FLM signal 930 to apply the emission signal to the first area 910 and the second area 920. As the emission signal is applied to the first area 910 and the second area 920, the entire area 935 of the display panel 905 may be turned on.

As described above with reference to FIG. 6A or 6B, a portion (e.g., light emitting part 649 in FIGS. 6A and 6B) of the sensor (e.g., sensor 645 in FIGS. 6A and 6B) may be disposed over the rear surface of the display (e.g., second direction © in FIGS. 6A and 6B). In this arrangement, when the display is turned on and the sensor is operated (for example, when light is output by at least one light source included in the light emitting part of the sensor), the output light may affect the display. For example, light may leak, and a blinking spot may occur on the display due to the light leakage.

In certain embodiments, when a signal for activating the sensor is detected under the control of the processor, the display driving circuit may control the emission driver (ED) so as not to supply an emission signal through the line (e.g., line 820 in FIG. 8) to the gate terminals of the first, fifth and sixth thin film transistors TR1, TR5 and TR6. In addition to turning off the first, fifth and sixth thin film transistors TR1, TR5 and TR6, the display driving circuit may control the emission FLM signal 940 to apply the emission signal only to the second area 920 except for the first area 910, so that at least one pixel included in the corresponding area of the display is turned off. When light is output from at least one light source included in the light emitting part of the sensor, as at least one pixel included in the corresponding area of the display is turned off, it is possible to prevent the organic light emitting diode (OLED) from being turned on due to light leakage.

FIG. 10 is a flowchart 1000 depicting a display control method according to certain embodiments.

With reference to FIG. 10, at operation 1010, the processor (e.g., processor 120 in FIG. 1) may determine whether a signal for activating the sensor (e.g., sensor 645 in FIGS. 6A and 6B) is detected. For example, the signal for activating the sensor may be a signal for detecting the proximity of an external object on the display or a signal for executing a specific application (e.g., telephone application).

In one embodiment, upon detecting a signal for activating the sensor at operation 1010, at operation 1020, the processor may control the display driving circuit (DDI) not only to turn off at least one pixel included in a first area (e.g., first area 910 in FIG. 9) of the display (e.g., a portion area of the display) in which the sensor (e.g., sensor 645 in FIGS. 6A and 6B) is disposed but also to turn on at least one pixel included in second area (e.g., second area 920 in FIG. 9) of the display (e.g., another area of the display) excluding the first area (e.g., first area 910 in FIG. 9).

In one embodiment, while the display is turned on, when a signal for sensing the proximity of an external object on the display is detected (when the sensor is operated, for example, when light is output from at least one light source included in the light emitting part of the sensor), the processor may perform operation 1020 described above. For instance, when a current of a certain level flows in the light emitting part of the sensor (e.g., proximity sensor), the light emitted by the LED may be reflected by an external object and received by the light receiving part (e.g., light receiving part 647 in FIGS. 6A and 6B) such as a photo diode. The processor may calculate the distance between the electronic device (e.g., electronic device 101 in FIG. 1) and the external object based on the amount of light reflected by the external object and received by the light receiving part. The processor may identify the proximity of the external object on the display based on the calculated distance between the electronic device and the external object. For example, if the calculated distance between the electronic device and the external object is within a specified range, the processor may determine that the external object is proximate to the display. Here, the processor has been described as determining whether an external object is proximate to the display, but the disclosure is not limited thereto. For example, the proximity of an external object to the display may be determined by a sensor hub including a micro controller unit (MCU). The sensor hub may determine whether an external object is proximate on the display through at least one sensor on behalf of the processor.

In another embodiment, when a signal for executing a specific application (e.g., telephone application) is detected, the processor may perform operation 1020 described above before the sensor is operated (activated) at operation 1030 described later (e.g., before outputting light by at least one light source included in the light emitting part of the sensor).

In one embodiment, at operation 1030, the processor may control the display driving circuit to output light through at least one light source included in the light emitting part of the sensor (e.g., light emitting part 649 of the sensor 645 in FIGS. 6A and 6B).

In one embodiment, upon not detecting a signal for activating the sensor at operation 1010, at operation 1040, the processor may control the display driving circuit to turn on a plurality of pixels included in the display. The electronic device according to certain embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that certain embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Certain embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor(e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. The term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a display including a plurality of pixels;
at least one processor electrically connected to the display;
a display driving circuit to drive the display; and
a sensor disposed on at least an upper portion of a rear surface of the display,
wherein, when a signal for activating the sensor is detected, the processor is configured to:
control the display driving circuit to turn off at least one pixel included in a first area of the display where the sensor is disposed among the plurality of pixels; and
control the display driving circuit to turn on at least one pixel included in a second area of the display excluding the first area among the plurality of pixels.

2. The electronic device of claim 1, wherein sensor comprises:
a light emitting part disposed on the rear surface of the display overlapping at least a portion of an upper region of the display; and
a light receiving part of the sensor disposed on the rear surface of the display overlapping at least another portion of the display.

3. The electronic device of claim 2, wherein the transmittance of an outer region not overlapping the display is different from the transmittance of at least a portion of the upper region of the display.

4. The electronic device of claim 2, wherein the processor is configured to control the display driving circuit to output light through at least one light source included in the light emitting part of the sensor while at least one pixel included in the first area of the display is turned off and at least one pixel included in the second area of the display excluding the first area is turned on.

5. The electronic device of claim 1, wherein a pixel driving circuit for each of the plurality of pixels included in the display includes:
a capacitor connected between a first node and a high power supply voltage wiring;
an organic light emitting diode;
a first switch connected between a third node and a fourth node;
a second switch connected between a second node and the third node to be turned on by a scan signal of a current scan line;
a third switch connected between the fourth node and a fifth node to be turned on by the scan signal of the current scan line;
a fourth switch connected between the first node and an initialization voltage wiring to be turned on by a scan signal of a previous scan line;
a fifth switch connected between the high power supply voltage wiring and the third node;
a sixth switch connected between the fourth node and the organic light emitting diode; and
a seventh switch connected between the initialization voltage wiring and the organic light emitting diode.

6. The electronic device of claim 5, wherein the pixel driving circuit includes a wiring connected to the fifth switch, the sixth switch, and an emission driver.

7. The electronic device of claim 6, wherein the pixel driving circuit for each of the at least one pixel included in the first area of the display where the sensor is disposed further comprises wiring connected to the first switch and the emission driver.

8. The electronic device of claim 7, wherein, when the signal for activating the sensor is detected, the processor is configured to control the emission driver not to apply an emission signal to the first switch, the fifth switch, and the sixth switch by using the display driving circuit for each of at least one pixel included in the first area of the display.

9. The electronic device of claim 8, wherein, when the signal for activating the sensor is detected, the processor is configured to control the emission driver to apply the emission signal to the first switch, the fifth switch, and the sixth switch by using the display driving circuit for each of at least one pixel included in the second area of the display excluding the first area.

10. The electronic device of claim 8, wherein, when the signal for activating the sensor is detected, the processor is configured to control the emission driver to apply the emission signal to a first group composed of at least one pixel included in the second area of the display excluding the first area by using the display driving circuit, and wherein, when the signal for activating the sensor is not detected, the processor is configured to control the emission driver to apply the emission signal to the first group and a second group composed of at least one pixel included in the first area of the display by using the display driving circuit.

11. A method for an electronic device to control a display, the method comprising:
detecting a signal for activating a sensor;
controlling a display driving circuit to turn off at least one pixel included in a first area of the display where the sensor is disposed among a plurality of pixels included in the display; and
controlling the display driving circuit to turn on at least one pixel included in a second area of the display excluding the first area among the plurality of pixels.

12. The method of claim 11, wherein the sensor includes a light emitting part that is disposed on a rear surface of the display so as to overlap at least a portion of an upper region of the display, and a light receiving part that is disposed on the rear surface of the display so as to overlap at least another portion of the display.

13. The method of claim 12, wherein the transmittance of an outer region not overlapping the display is different from the transmittance of at least a portion of the upper region of the display.

14. The method of claim 12, further comprising outputting light through at least one light source included in the light emitting part of the sensor.

15. The method of claim 11, wherein a pixel driving circuit for each of the plurality of pixels included in the display includes:
a capacitor connected between a first node and a high power supply voltage wiring;
an organic light emitting diode;
a first switch connected between a third node and a fourth node;
a second switch connected between a second node and the third node to be turned on by a scan signal of a current scan line;
a third switch connected between the fourth node and a fifth node to be turned on by the scan signal of the current scan line;
a fourth switch connected between the first node and an initialization voltage wiring to be turned on by a scan signal of a previous scan line;
a fifth switch connected between the high power supply voltage wiring and the third node;
a sixth switch connected between the fourth node and the organic light emitting diode; and
a seventh switch connected between the initialization voltage wiring and the organic light emitting diode.

16. The method of claim 15, wherein the pixel driving circuit includes a wiring connected to the fifth switch, the sixth switch, and an emission driver.

17. The method of claim 16, wherein the pixel driving circuit for each of the at least one pixel in the first area where the sensor is disposed further includes a wiring connected to the first switch and the emission driver.

18. The method of claim 17, wherein controlling the display driving circuit to turn off at least one pixel comprises controlling the emission driver not to apply an emission signal to the first switch, the fifth switch, and the sixth switch for each of at least one pixel included in the first area of the display.

19. The method of claim 18, wherein controlling the display driving circuit to turn on at least one pixel comprises controlling the emission driver to apply the emission signal to the first switch, the fifth switch, and the sixth switch for each of at least one pixel included in the second area of the display excluding the first area.

20. The method of claim 18, further comprising:
controlling, when the signal for activating the sensor is detected, the emission driver to apply the emission signal to a first group composed of at least one pixel included in the second area of the display excluding the first area; and
controlling, when the signal for activating the sensor is not detected, the emission driver to apply the emission signal to the first group and a second group composed of at least one pixel included in the first area of the display.
